(19) United States
(12) Patent Application Publication
(10) Pub. No.: US 2006/0244284 A1
(43) Pub. Date: Nov. 2, 2006

(54) Convertible/removable hard top for motorscooters and the like

(76) Inventors: Mathu Solo, Sugar Land, TX (US); Jian Wang, Huangyan (CN)

Correspondence Address: Mark A. Tidwell;Jackson Walker L.L.P., Suite 2100, 112 E. Pecan Street, San Antonio, TX, 78205-1521, US

(21) Appl. No.: 11/116,770

(22) Filed: Apr. 28, 2005

(51) Int. Cl. B60J 7/12

(52) U.S. Cl. 296/107.01

(57) ABSTRACT

A convertible/removable hard top for motorscooters and the like, which protects the riders from the elements. The convertible/removable hard top cover may be raised, lowered or completely removed depending on the operator's needs. When the convertible/removable hard top cover is in a raised position, the hard top cover is releasably attached to a rear mount and a windshield assembly. When the convertible/removable hard top cover is in a stored position, the hard top cover is disengaged from the windshield assembly and folded into the rear storage compartment. When the convertible/removable hard top cover is completely removed, the hard top cover is disengaged from the windshield assembly and the rear mount, thus allowing storage of the hard top cover apart from the motorscooter and the like. In one embodiment, a kit comprising a windshield assembly and convertible hard top is provided for aftermarket conversion of prior art motorscooters.

### BACKGROUND OF THE INVENTION

1. Field of the Invention

The present invention relates generally to the field of motorized scooters. In particular, the present invention relates to a hard top for motorized scooters which can function as both a convertible top and a removable top, depending upon the operator's needs.

2. Description of the Prior Art

Motorscooters and similar two-wheeled motorized vehicles are cyclic-type vehicles in which the operator and its passengers, if any, are usually exposed to the elements. These elements, including rain, can significantly restrict the usage of the vehicles or impact the comfort of the riders. A typical prior art motorscooter generally includes a passenger compartment with a partial windscreen at the front of the passenger compartment, and passenger seat disposed within the passenger compartment. Some motorscooters may also include a storage compartment behind the passenger seat. In most cases, motorscooters of the prior art do not include any type of top or covering over the passenger compartment.

There have been several attempts in the prior art to provide tops for these vehicles. However, for the most part, such tops all suffer from deficiencies which limit their usefulness according to certain situations.

More specifically, the prior art teaches fixed hard tops, removable hard tops, and convertible tops made of fabric. One example is the BMW C1 which provided a fixed frame and hard top over the passenger compartment and was marketed as having enhanced safety features over open compartment motorscooters. However, fixed hard tops are not very appealing to motorscooter enthusiasts who desire the “outdoor” experience associated with motorscoooters and the like. In other words, the feel of riding a motorscooter is significantly diminished.

Likewise, removable hard tops suffer deficiencies. While these tops provide more flexibility than fixed hard tops to the extent they can be utilized during inclement weather to protect a motorscooter's riders, and such tops can be fully removed to permit the aforementioned “outdoor” experience, removable hard tops are typically bulky, requiring complicated installation and removal procedures as well as a place to store said tops when not in use. In this regard, because of their bulky nature, the tops must typically be stored in a garage or similar storage facility. As such, they do not lend themselves to removal upon a whim, or readily manipulated with the changing weather. They require advance planning and are time consuming to manipulate. One cannot simply step outside at any moment and decide to remove (or install) such tops. Thus, in the brief periods of bad weather, a rider is likely to find oneself without any protection from the elements. On the other hand, should the weather clear, the rider is likely to find himself on the road and unable to enjoy the “outdoor” experience due to the drawbacks of removal and storage of the top.

Convertible fabric tops solve some of the problems associated with the fixed hard tops and removable hard tops. They allow the operator to have the top up when needed and allow the operator to have the top down when desired. Typically such fabric convertible tops retract for storage in a compartment on the vehicle. However, a major disadvantage of the fabric convertible top is that it is relatively easily torn or damaged as a result of which, it has a relatively short life span. This is particularly true of fabric convertible tops utilized for motorscooters and the like, where the top secures to the motor scooter only along a back edge and a front edge adjacent the windscreen such that the passenger compartment is not fully enclosed. In this case, the top is much more exposed and subject to various elements, such as drag forces placed on the inside of the top as the vehicle is moving. In a similar vein, while a convertible fabric top may shield the passenger compartment from the elements, it offers little protection to the passenger compartment from a safety standpoint and is likely to easily collapse under the application of an external force. Another problem with convertible fabric tops is that they occupy precious cargo space when they are in the stored position. As those skilled in the art will understand, cargo space is at a premium on small motor vehicles such as motorscooters. In the case where a motorscooter incorporates a fabric convertible top, the motorscooter operator may not be able to store necessary cargo if he elects to ride with the top in a retracted, stored configuration. Alternatively, if the operator utilizes the fabric convertible top storage space for cargo, the operator will not be able to retract the top.

Notwithstanding the foregoing, none of the prior art tops are after-market tops. To the extent the prior art teaches tops for motorscooters, these tops are integral components of the original motorscooters to which they are attached. As described above, to the extent prior art motorscooters without tops incorporate windscreens at all, the windscreens typically only partially protect the passenger compartment. In other words, the windscreens do not extend fully to a height above the head of an individual riding within the passenger compartment.

It is therefore an object of the present invention to provide a motorscooter with a hard top that is removable.

It is a further object of the present invention to provide a motorscooter with a hard top that is retractable as a convertible.

It is another object of the invention to provide a motorscooter with a storage compartment that can be used to contain cargo and/or a retractable hard top.

It is another object of the present invention to provide a novel, convertible/removable hard top which is of relatively simple construction and design and which is durable and reliable in operation.

These, and other, objects and advantages of the present invention will become more clear after careful consideration is given to the following detailed description of the preferred embodiment.

### SUMMARY OF THE INVENTION

The invention disclosed and claimed is directed to a removable, convertible hard top for motorscooters and the like which can be raised and lowered as desired by the operator. The convertible hard top is also detachably mounted so that it can be removed and stored when needed. Alternatively, the convertible hard top can be collapsed into a motorscooter's cargo or storage compartment without detaching it from the motorscooter, preferably while retaining at least a portion of the storage space for cargo. The hard top has a much longer life span than a fabric top and, when deployed, provides much greater protection to the passenger compartment than a fabric top. In one embodiment, the invention provides an after-market kit for retrofitting prior art motorscooters with a removable/retractable convertible hard top.

The convertible/removable hard top has a back portion and a top portion. The back portion of the convertible/removable hard top includes a transparent section which is inserted into the back portion, thus allowing it to function as a rear window. This transparent section is secured to the back portion but is removable for repairs, replacement or as otherwise desired. In the preferred embodiment, this transparent is a polycarbonate material, such as Lexan, or glass. The back portion of the convertible/removable hard top detachably engages rear mounts which are mounted to the frame, of the motorscooter behind the passenger compartment. The top portion of the convertible/removable hard top is secured to the back portion of the convertible/removable hard top at a trailing edge and the windshield of the motorscooter at a leading edge.

The after-market kit further includes a substitute windshield assembly that is designed to accommodate the foregoing convertible/removable hard top. The windshield assembly provides a full windscreen with a height that extends sufficiently above the passenger compartment so as to provide an attachment point to which the convertivle/removable hard top can be latched. In most cases, because of their limited height, windscreens of the prior art require little or no frame. The windshield assembly that comprises a part of the convertible/removable hard top conversion kit has a full rigid frame that supports the windshield. In addition to functioning at a point of attachment for the top of the invention, such a frame is needed because of the force of the wind on windshield.

The convertible/removable hard top may operate in three different configurations. In the first configuration, the convertible/removable hard top is in a deployed or “up” position. This configuration will allow the top to partially enclose the passenger compartment of the motorscooter, protecting passengers from exposure to elements such as rain. The convertible/removable hard top may also operate in a stored configuration. Preferably, the top is stored behind the rider in the rear storage compartment. This position allows the passengers to enjoy the ride and the “outdoor” experience of riding a motorscooter while still allowing the possibility of raising the hard top if desired, such as in the case of bad weather. Finally, in a third configuration, the convertible/removable hard top may be completely removed from the motorscooter. This configuration allows the rider to enjoy the “outdoor” experience of riding a motorscooter while maximizing available cargo space in the storage compartment. This position would be most desirable on trips where cargo is required and the weather is good.

### BRIEF DESCRIPTION OF THE DRAWINGS

FIG. 1 is a side elevational view of the motorscooter of the prior art with a fixed hard top.

FIG. 2 is a side view of the motorscooter of the current invention with the convertible/removable hard top in a deployed position.

FIG. 3 is an exploded view of the convertible/removable hard top.

FIG. 4 is an exploded view of the windshield assembly of the conversion kit.

FIG. 5 is an elevation view of the motorscooter of the motorscooter of the current invention with the convertible/removable hard top in a deployed position.

### DETAILED DESCRIPTION OF THE PREFERRED EMBODIMENTS

In the detailed description of the invention, like numerals are employed to designate like parts throughout. Various items of equipment, such as fasteners, fittings, etc., may be omitted to simplify the description. However, those skilled in the art will realize that such conventional equipment can be employed as desired.

With reference to FIG. 1, a motorscooter 10 of a prior art with a fixed hard top 12 is illustrated. As shown, the hardtop 12 is integrally formed with motorscooter 10 and as such, is not removable. These prior art hard tops are not very appealing to motorscooter operators who desire the “outdoor” experience associated with motorscooters.

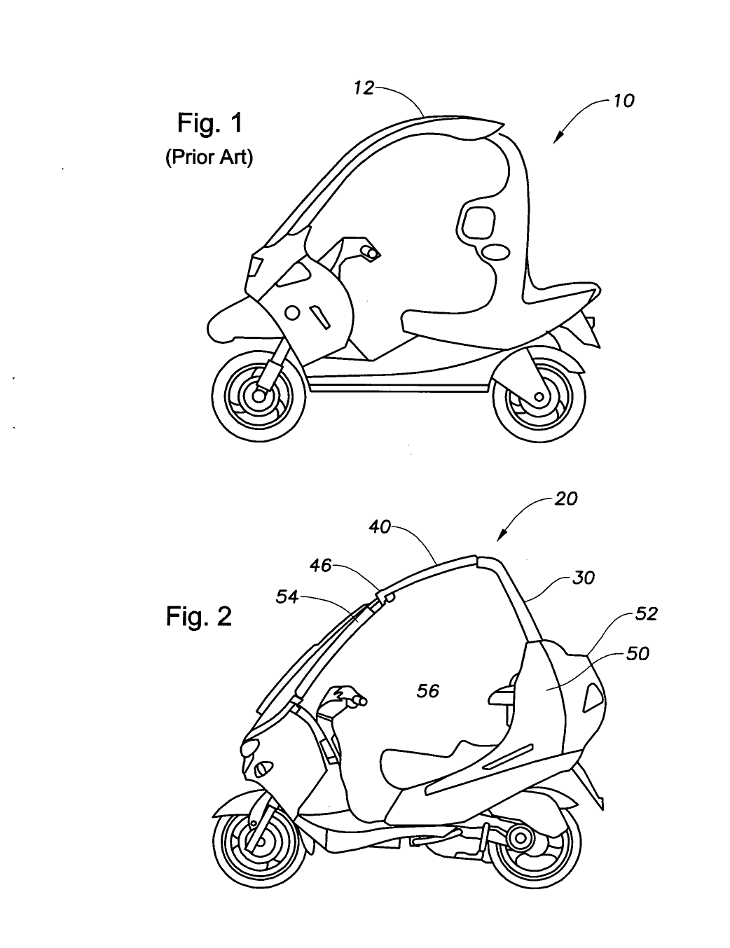

With reference to FIG. 2, there is shown a motorscooter 50 having a convertible/removable hard top 20 of the invention. Hard top 20 generally is comprised of a back portion 30 and a top portion 40. Top portion 40 attaches to motorscooter 50 adjacent windshield assembly 54, while back portion 30 attaches to motorscooter 50 behind passenger compartment 56 adjacent storage compartment 52.

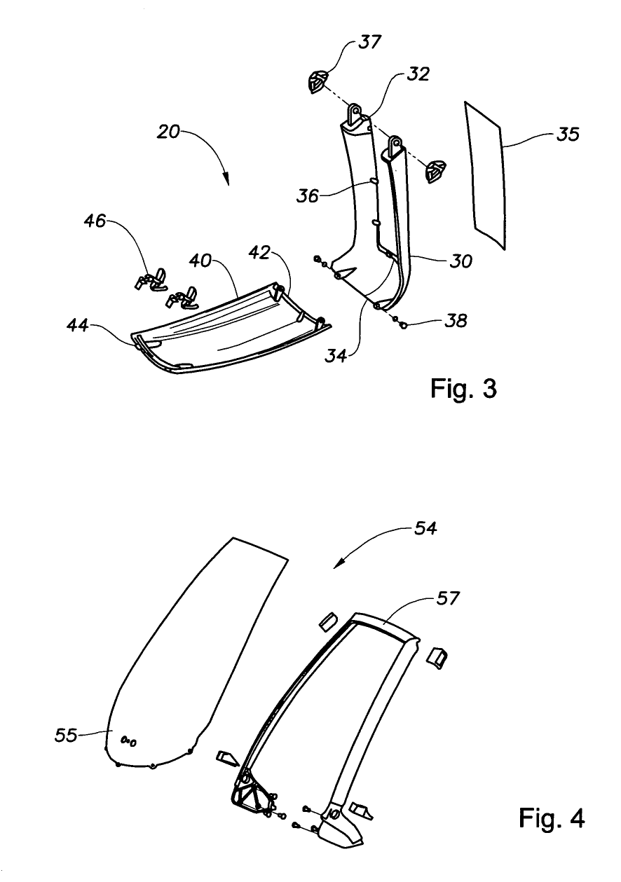

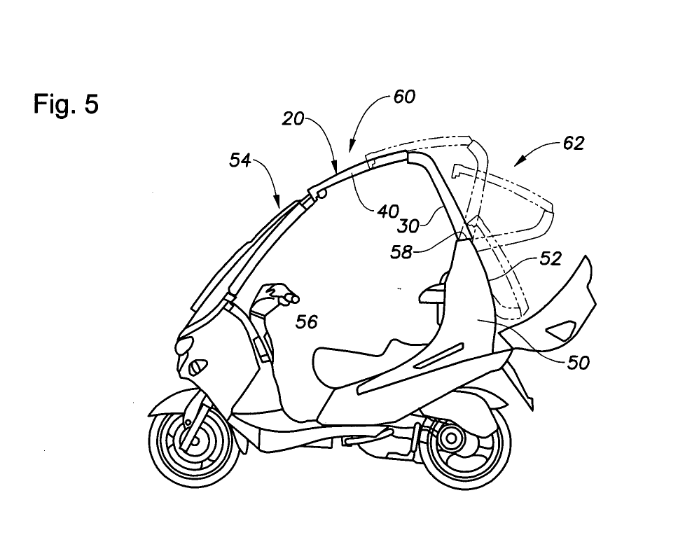

In FIG. 3, the parts for the convertible/removable hard top 20 are illustrated more specifically. As shown, convertible/removable hard top 20 comprises a back portion 30, a top portion 40, and fasteners 37 and 46 for pivotally and releasably attaching hard top 20 to the motorcycle 50. Specifically, fasteners 37 pivotally attach back portion 30 to motorcycle 50 adjacent the seat, while fasteners 46 detachably secure the top portion 40 to the windshield assembly 54. Fasteners 38 pivotally attach back portion 30 to top portion 40. The back portion 30 of the convertible/removable hard top 20 includes a transparent section 35, thus allowing it to function as a rear window. In one preferred embodiment, this transparent is a polycarbonate material, such as Lexan, or glass. Transparent section 35 is secured to the back portion 30 but is removable for repairs, replacement, or as otherwise desired. The transparent section 35 may be secured to the back portion 30 utilizing any known form of attachment. In one preferred embodiment, guiding rails 36 are utilized to secure transparent section 35 to back portion 30. Back portion 30 is further defined by a first edge 34 and a second edge 32, wherein the second edge 32 is pivotally and releasably mounted by fasteners 37 to rear mounts 58 (FIG. 5) located behind the passenger compartment 56 on the motorscooter frame 50. Top portion 40 is defined by a leading edge 44 and a trailing edge 42, wherein the trailing edge 42 is pivotally attached to the first edge 34 of the back portion 30. The trailing edge 42 is generally pivotally attached to the first edge 34 by fasteners 38 as described above. In one preferred embodiment, leading edge 44 of the top portion 40 is detachably secured to windshield assembly 54 by clamps or latches 46.

FIG. 4 illustrates windshield assembly 54 which comprises a windshield 55 at least partially supported by a rigid frame 57. Rigid frame 57 functions as an attachment point for top 20 and in particular serves as a support to which latches 46 can be releasably secured. Windshield assembly 54 provides a full windscreen with a height that extends sufficiently above passenger compartment 56 so as to provide an attachment point to which the convertivle/removable hard top 20 can be latched. Additionally, frame 57 provides support to windshield 55 particularly when windshield 55 is subjected to external wind force.

In one embodiment, the invention is a conversion kit for retrofitting prior art motorscooters having windscreens. The kit includes a full windshield assembly 54 and a removable/retractable convertible hard top 20. Windshield assembly 54 can quickly be substituted for a windscreen on a prior art scooter. With windshield assembly 54 accordingly attached, the motorscooter is disposed for use with removable/retractable convertible hard top 20.

As depicted in FIG. 5, the convertible/removable hard top 20 of the current invention may operate in three different positions. Each of these three different positions may be achieved manually or electrically. The first position is illustrated at 60, wherein the convertible/removable hard top 20 is shown in the deployed position. In this first position, back portion 30 is pivotally and releasably mounted by fasteners 37 to the rear mounts 58 on the motorscooter frame 50 located behind the passenger compartment 56. The top portion 40 pivotally attaches to the back portion 30 by fastners 38. The top portion 40 also releasably attaches to the windshield assembly 54 by clamps or latches 46.

Illustrated at 62 is convertible/removable hard top 20 is convertible/removable hard top 20 being moved to a stored or retracted position. When in a stored position, the convertible/removable hard top 20 is stored behind the rider in the rear storage compartment 52 by releasing clamps 46 from windshield assembly 54, folding the top portion 40 into the back portion 30, and collapsing the assembly into storage compartment 52 by pivoting top 20 on rear mounts 58. Rear mounts 58 are positioned adjacent storage compartment 52 so as to permit top 20 to be collapsed into storage compartment 52 without detaching top 20 from rear mounts 58. In this way, top 20 can be quickly deployed from its position within storage compartment 52. In one preferred embodiment, the storage compartment 52 is of sufficient volume to accommodate top 20 while still providing space for some cargo.

Alternatively, the convertible/removable hard top 20 may be completely removed from the motorscooter 50. The convertible/removable hard top 20 may be removed by releasing the clamps 46 located where the top portion 40 releasably attaches to the windshield assembly 54, folding the top portion 40 into the back portion 30, and further disengaging back portion 30 from the rear mounts 58.

The convertible/removable hardtop 20 solves many of the prior art shortcomings. The main advantage, among others, of the current invention is that the convertible/removable hardtop 20 can be operated in three different configurations, which include a deployed position, a stored position and a removed position. The advantage of having the convertible/removable hardtop 20 in the deployed position is that the motorscooter operator and its passenger may use the vehicle when exposure to the elements is undesirable, such as during rain. The advantage of having the convertible/removable hardtop 20 in the stored or retracted position is that the motorscooter operator and its passenger can enjoy the ride and experience the true “outdoor” feel of riding a motorscooter while maintaining the option of raising the convertible/removable hard top 20 in case of inclement weather or the like. The advantage of having the convertible/removable hardtop 20 in the removed position is that the motorscooter operator and its passenger can enjoy the ride and experience the true “outdoor” feel of riding a motorscooter while maximizing the capacity of storage compartment 52. This position would be useful on trips where some cargo is required and the weather is good. Additionally, the advantage of having a convertible/removable top which is a hardtop is that the hardtop is more durable than a fabric top, such that it will last longer than a fabric top. Additionally, the hard top will provided a higher degree of protection to the operator and its passenger than fabric tops.

While a preferred embodiment of the invention has been described, it is appreciated that variations and modifications may be made without departing from the scope and spirit of the following claims.

What is claimed is:

1. A convertible/removable hard top for a motorscooter having a passenger compartment, a windshield assembly at the front of the passenger compartment, a passenger seat disposed within the passenger compartment and a storage compartment behind the passenger seat, said top comprising:
a. a top portion, said top portion having a rigid body with a leading edge and a trailing edge;
b. a fastener for attaching the leading edge of said top portion to the windshield assembly;
c. a back portion, said back portion having a rigid body with a first edge and a second edge, wherein said first edge is pivotally attached to the trailing edge of the top portion and said second edge is pivotally and releasably attached to said motorscooter adjacent said storage compartment.

2. The convertible/removable hard top of claim 1, wherein said top is movable between a first position in which leading edge of said top portion is disposed adjacent said windshield assembly and said back portion is substantially perpendicular to said top portion to a second position where said top portion and said back portion are folded relative to one another and disposed within said storage compartment.

3. The convertible/removable hard top of claim 2, where said back portion remains pivotally attached to said motorscooter while said top is disposed within said storage compartment.

4. The convertible/removable hard top of claim 1, wherein said top is movable between a first position in which leading edge of said top portion is disposed adjacent said windshield assembly and said back portion is substantially perpendicular to said top portion to a third position where said top portion and said back portion are folded relative to one another and where the second edge of said back portion is released from said motorscooter and said front portion and said back portion are stored apart from said motorscooter.

5. The convertible/removable hard top of claim 1, wherein said top is movable between a first position in which leading edge of said top portion is disposed adjacent said windshield assembly and said back portion is substantially perpendicular to said top portion to a third position where said second edge of said back portion is released from said motorscooter and said front portion and said back portion are stored apart from said motorscooter.

6. The convertible/removable hard top of claim 2, wherein said top is movable between said first position and said second position by a remote.

7. The convertible/removable hard top of claim 1 wherein said back portion includes a transparent section.

8. The convertible/removable hard top of claim 1 wherein said fastener at said leading edge is a latch for releasably securing said leading edge of said top portion to said windshield assembly.

9. A device as in claim 1 further comprising a plurality of portions.

10. A motorscooter comprising:
a. a passenger compartment;
b. a windshield assembly at the front of the passenger compartment;
c. a passenger seat disposed within the passenger compartment;
d. a storage compartment behind the passenger seat; and
e. a convertible/removable hard top, said hard top comprising:
f. a top portion, said top portion having a rigid body with a leading edge and a trailing edge;
g. a first fastener for releasably securing the leading edge of said top portion to the windshield assembly;
h. a back portion, said back portion having a rigid body with a first edge and a second edge, wherein said first edge is pivotally attached to the trailing edge of the top portion;
i. a second fastener for pivotally and releasably attaching said second edge to said motorscooter adjacent said storage compartment;
j. wherein said top is movable between a first position in which leading edge of said top portion is disposed adjacent said windshield assembly and said back portion is substantially perpendicular to said top portion to a second position where said top portion and said back portion are folded relative to one another and disposed within said storage compartment while said top remains attached to said motorscooter by said second fastener.

11. A conversion kit for installing a convertible hard top on a motorscooter, said kit comprising a combination:
a. a windshield assembly comprising a windscreen at least partially supported by a rigid frame;
b. first fasteners for securing said windshield assembly to said motorscooter; and
c. a convertible hard top comprising a top portion, said top portion having a rigid body with a leading edge and a trailing edge; a second fastener for releasably securing the leading edge of said top portion to the windshield assembly; a back portion, said back portion having a rigid body with a first edge and a second edge, wherein said first edge is pivotally attached to the trailing edge of the top portion; and a hinge attached to said second edge
d. third fasteners for pivotally attaching said hinge to said motorscooter.
